(19) United States
(12) Patent Application Publication
(10) Pub. No.: US 2022/0245494 A1
(43) Pub. Date: Aug. 4, 2022

(54) PARAMETER ESTIMATION DEVICE, PARAMETER ESTIMATION METHOD, AND PARAMETER ESTIMATION PROGRAM

(71) Applicant: NIPPON TELEGRAPH AND TELEPHONE CORPORATION, Tokyo (JP)

(72) Inventors: Masahiro KOJIMA, Tokyo (JP); Takeshi KURASHIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/622,323

(22) PCT Filed: Jun. 26, 2019
(86) PCT No.: PCT/JP2019/025472

§ 371 Date: Dec. 23, 2021

(51) Int. Cl. G06N 7/00

(52) U.S. Cl. CPC G06N 7/005

(57) ABSTRACT

To estimate a parameter of a Markov chain model including unobservable states. An input unit (101) receives input data including a state set of a Markov chain to be estimated, a set of observable states, and censored transition data represented by a transition between the observable states and initial states of the observable states, an estimation unit (102) optimizes an objective function including a term representing a degree of match of a transition probability of a first Markov chain generating the censored transition data and a transition probability of a second Markov chain made from a model representing the Markov chain to be estimated and the set of the observable states, by using a parameter, and estimates the parameter, and an output unit (103) outputs the parameter estimated.

### TECHNICAL FIELD

The disclosed technique relates to a parameter estimation device, a parameter estimation method, and a parameter estimation program.

### BACKGROUND ART

The Markov process is a highly versatile model that can represent a variety of dynamic systems and is used in a variety of applications, such as analysis of human or traffic flow in cities, analysis of ticket window queues, and the like.

Because the transition probability and the initial state probability, which are the parameters having the Markov process, are commonly not known, it is necessary to perform estimation from observation data. If ideal observation data obtained by observing transitions between states are available, the transition probability can be estimated based on the number of transitions between the states (NPL 1).

### CITATION LIST

### Non Patent Literature

NPL 1: Patrick Billingsley, “Statistical Methods in Markov Chains”, The Annals of Mathematical Statistics, pp. 12-40, 1961.

### SUMMARY OF THE INVENTION

### Technical Problem

However, observation data collected in a real environment are expressed as transition data (hereinafter referred to as “censored transition data”) in which observation is partially aborted due to the presence of unobservable states. Existing parameter estimation techniques cannot estimate parameters of an original Markov chain having observable states and unobservable states from censored transition data. Because unobservable states do not appear at all in observation data, an estimation result showing that the probability of transition to an unobservable state is 0 is obtained.

The disclosed technique has been made in view of the foregoing, and has an object to provide a parameter estimation device, method, and program for estimating parameters of a Markov chain model including unobservable states.

### Means for Solving the Problem

A first aspect of the present disclosure is a parameter estimation device including: an input unit configured to receive input data including a state set of a Markov chain to be estimated, a set of observable states, and censored transition data represented by a transition between the observable states and initial states of the observable states; an estimation unit configured to optimize an objective function including a term representing a degree of match of a transition probability of a first Markov chain generating the censored transition data received by the input unit and a transition probability of a second Markov chain made from a model representing the Markov chain to be estimated and the set of the observable states, by using a parameter to estimates the parameter; and an output unit configured to output the parameter estimated by the estimation unit.

A second aspect of the present disclosure is a parameter estimation method including: receiving, by an input unit, input data including a state set of a Markov chain to be estimated, a set of observable states, and censored transition data represented by a transition between the observable states and initial states of the observable states; optimizing, by an estimation unit, an objective function including a term representing a degree of match of a transition probability of a first Markov chain generating the censored transition data received by the input unit and a transition probability of a second Markov chain made from a model representing the Markov chain to be estimated and the set of the observable states, by using a parameter, and estimating the parameter; and outputting, by an output unit, the parameter estimated by the estimation unit.

A third aspect of the present disclosure is a parameter estimation program for causing a computer to function as: an input unit configured to receive input data including a state set of a Markov chain to be estimated, a set of observable states, and censored transition data represented by a transition between the observable states and initial states of the observable states; an estimation unit configured to optimize an objective function including a term representing a degree of match of a transition probability of a first Markov chain generating the censored transition data received by the input unit and a transition probability of a second Markov chain made from a model representing the Markov chain to be estimated and the set of the observable states, by using a parameter to estimate the parameter; and an output unit configured to output the parameter estimated by the estimation unit.

### Effects of the Invention

According to the disclosed techniques, it is possible to estimate a parameter of a Markov chain model including unobservable states.

### BRIEF DESCRIPTION OF DRAWINGS

FIG. 1 is a schematic diagram illustrating an example of observation data in an ideal environment.

FIG. 2 is a schematic diagram illustrating an example of observation data in a real environment.

FIG. 3 is a schematic diagram illustrating an example of observation data in an ideal environment.

FIG. 4 is a schematic diagram illustrating an example of observation data in a real environment.

FIG. 5 is a schematic diagram illustrating an overall image of a process according to the present embodiment.

FIG. 6 is a block diagram illustrating a hardware configuration of a parameter estimation device according to the present embodiment.

FIG. 7 is a block diagram illustrating an example of a functional configuration of the parameter estimation device according to the present embodiment.

FIG. 8 is a flowchart illustrating a sequence of parameter estimation processing according to the present embodiment.

### DESCRIPTION OF EMBODIMENTS

Hereinafter, one example of embodiments of the disclosed technique will be described with reference to the drawings. Note that, in the drawings, the same reference numerals are given to the same or equivalent constituent elements and parts. Dimensional ratios in the drawings are exaggerated for the convenience of description and thus may be differ from actual ratios.

First, prior to describing the details of the embodiments, censored transition data will be described.

As noted above, observation data collected in a real environment is expressed as data in which some states cannot be observed, i.e., censored transition data where observation is partially aborted, because there are unobservable states.

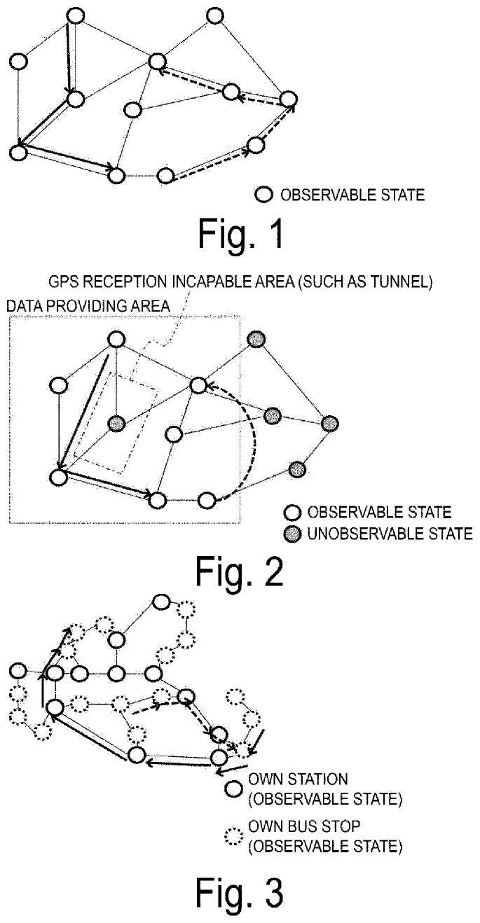

A case in which some states cannot be observed will be described in detail using examples. First, a first example is movement history data of a vehicle in an area provided by a taxi company or the like. The movement history data is data obtained by converting location information such as Global Positioning System (GPS) data, for example. In this case, the movement of the vehicle can be expressed as a Markov chain where each point in the range of travel of the vehicle is a state and each movement of the vehicle between the points is a state transition. FIG. 1 illustrates a case where states corresponding to all points within the range of interest are observable, and the transition probability between states can be estimated based on movement history data indicated by solid arrows and dashed arrows in FIG. 1.

Meanwhile, as shown in FIG. 2, movement history data between states outside a data providing area (area indicated by dotted lines in FIG. 2) is excluded from the data provided. Thus, a state in which the vehicle is located outside the data providing area is a state in which it is not possible to observe whether the vehicle is at a point corresponding to the state of vehicle located outside the data providing area. Even in the data providing area, an area where the GPS data cannot be received due to the presence of a shield such as a tunnel (the area indicated by dot-dash lines in FIG. 2) is similarly an unobservable state in which it is not possible to observe whether the vehicle is at a point corresponding to the state of vehicle in the data providing area.

Thus, as indicated by solid arrows and a dashed arrow in FIG. 2, the resulting observation data is expressed as censored transition data representing only transitions between observable states.

A second example of a case in which some states cannot be observed is movement history data from a railway or bus operating company. The movement history data in this case is data indicating a history of movement between own stations, bus stops, and stations and bus stops recorded by users presenting IC cards or the like at the time of entrance/exit or getting on/off

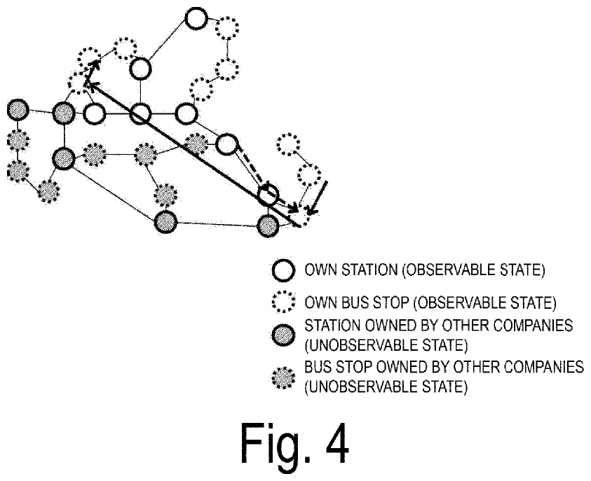

As an ideal situation, as shown in FIG. 3, one railway and bus operating company owns all stations and bus stops in an area. In this case, the transition probability between states can be estimated based on the movement history data indicated by solid arrows and dashed arrows in FIG. 3. However, in particular in urban areas and the like, as illustrated in FIG. 4, a case in which the company owns only some of the stations and bus stops in the area is considered to be common. Thus, movement history data obtained from the records of IC cards or the like presented by users at the time of entrance/exit or getting on/off are only those related to their own stations and bus stops, and movement history data related to stations and bus stops owned by other companies cannot be obtained.

Thus, similarly to the example described above, the observation data in this example is also expressed as censored transition data, which represents transitions between observable states only, as indicated by solid arrows and dashed arrows in FIG. 4.

As noted above, existing parameter estimation techniques cannot estimate parameters of an original Markov chain having observable and unobservable states from censored transition data. Thus, the disclosed technology proposes an approach to estimating parameters of an original Markov chain from censored transition data. In the disclosed technique, a theory related to a Markov chain (hereinafter referred to as “censored Markov chain”) having unobservable states is utilized. Embodiments according to the disclosed technique will be described in detail after the Markov chain and the censored Markov chain are described.

Note that in the present specification, “<<A>>” represents the letter A in cursive in mathematical equations (A is an arbitrary symbol), and “<A>” represents a bold letter A in mathematical equations.

Assume that <<X>>={1, 2, . . . , |<<X>>|} is a set of states. The Markov chain at discrete times on the state set <<X>> is defined as a stochastic process {Xₜ; t=1, 2, . . . } having the Markov property shown in Equation (1) below.

$$\begin{matrix}[ Math . 1 ] & \\ Pr ( {X}_{t + 1} = {x}_{t + 1} \vert {X}_{k} = {x}_{k} ; k = 0 , … , t ) = Pr ( {X}_{t + 1} = {x}_{t + 1} \vert {X}_{t} = {x}_{t} ) ( ∀ {x}_{k} ∈ χ , ∀ t ∈ {ℤ}_{\geq 0} ) & ( 1 )\end{matrix}$$

A Markov chain can be defined by a set of three elements {<<X>>, <<P>>, q}. <<P>>: <<X>>×<<X>>→[0, 1] is a transition probability, q: <<X>>>→[0, 1] is an initial state probability, which are defined as in Equation (2) below.

[Math. 2]

[symbol]

(xₙₑₓₜ|x) [symbol] Pr(Xᵢ₊₁=xₙₑₓₜ|Xₜ=x) and q(x₀) [symbol] Pr(C₀=x₀) (2)

Hereinafter, a Markov chain is assumed to be an irreducible Markov chain.

Further, the definition of a censored Markov chain is given. A censored Markov chain may be referred to as a censored process, a watched Markov chain, or an induced chain (References 1 to 3).

Reference 1: John G Kemeny, J Laurie Snell, and Anthony W Knapp, “Denumerable Markov Chains”, Vol. 40. Springer-Verlag New York, 1976.

Reference 2: David A Levin and Yuval Peres, “Markov Chains and Mixing Times”, Vol. 107. American Mathematical Soc., 2017.

Reference 3: Y Quennel Zhao and Danielle Liu, “The Censored Markov Chain and the Best Augmentation”, Journal of Applied Probability, Vol. 33, No. 3, pp. 623-629, 1996.

It is assumed that <<O>> is a subset of the state set <<X>>, where <<O>>⊆<<X>>. <<O>> represents a set of observable states. Similarly, a set of unobservable states x is written as <<U>>. The censored Markov chain {X^{c}ₜ; t=1, 2, . . . } is defined as a state X^{c}ₜ of the time t represents an observable state that appears at a t-th position by ignoring a state which is unobservable in the original Markov chain {X_{r′}; t′=1, 2, . . . }. The times at which observable states appear in the original Markov chain are written as σ₀, σ₁, . . . , σₜ, where X^{c}ₜ;=Xₒₜ. Intuitively, the censored Markov chain can be said to have only observable states extracted from the original Markov chain. The strict definitions are as follows.

### Definition 1: Censored Markov Chain

[Math. 3]

Sequence of points {σₜ; t=1,2, . . . } representing time Xₜ ϵ [symbol] is defined as:

σ₀=0(if X₀ϵ [symbol] ),σ₀=inf{m≥1:Xₘϵ [symbol] }(otherwise), σₜ=inf{m≥σᵢ₋₁:Xₘϵ [symbol] }.

The sequence X^{c}ₜ:=Xₒₜ obtained by observing Xₜ in the sequence σₜ is referred to as a censored Markov chain.

Hereinafter, it is assumed that states are rearranged without loss of generality, and the matrix representation of the transition probability of the Markov chain <P>, (<P>)_{xx′}=<<P>>(x′|x), and the vector representation of the initial state probability (q), (<q>)ₓ=q(x) are given by Equation (3) below.

$$\begin{matrix}[ Math . 4 ] & \\ \begin{matrix} & & u\end{matrix} \\ P = \begin{matrix} \\ u\end{matrix} ( \begin{matrix}{P}_{oo} & {P}_{ou} \\ {P}_{uo} & {P}_{uu}\end{matrix} ) , \\ \begin{matrix} & u & & \end{matrix} \\ q = ( \begin{matrix}{q}_{o} & {q}_{u}\end{matrix} ) & ( 3 )\end{matrix}$$

The matrices of <P>ₒₒ, <P>ₒᵤ, <P>ᵤₒ, and <P>ᵤᵤ are matrices having sizes of |<<O>>|×|<<O>>|, |<<O>>|×|<<U>>|, |<<U>>|×|<<O>>|, and |<<U>>|×|<<U>>|, respectively.

The following results are shown for the censored Markov chain.

### Theorem 1 (e.g., Lemma 6-6 (Reference 1))

The censored Markov chain is a Markov chain in accordance with the transition probability matrix shown in Equation (4) below.

[Math. 5]

R [symbol] Pₒₒ+Pₒᵤ(I−Pᵤᵤ)⁻¹Pᵤₒ (4)

The following theorem can be derived for the initial state probability with substantially similar proof as described above.

### Theorem 2

The initial state probability of the censored Markov chain is the initial state vector shown in Equation (5) below.

[Math. 6]

s [symbol] qₒ+qᵤ(I−Pᵤᵤ)⁻¹Pᵤₒ (5)

Theorems 1 and 2 show that the censored Markov chain made from the Markov chain {<<X>>, <<P>>, q} and the set of observable states <<O>> is a Markov chain {<<O>>, <<R>>, s}. <<R>> is a set of transition probabilities according to the transition probability matrix <R> described above, and is a set of initial state probabilities according to the initial state vector <s> described above.

Hereinafter, embodiments according to the disclosed techniques will be described.

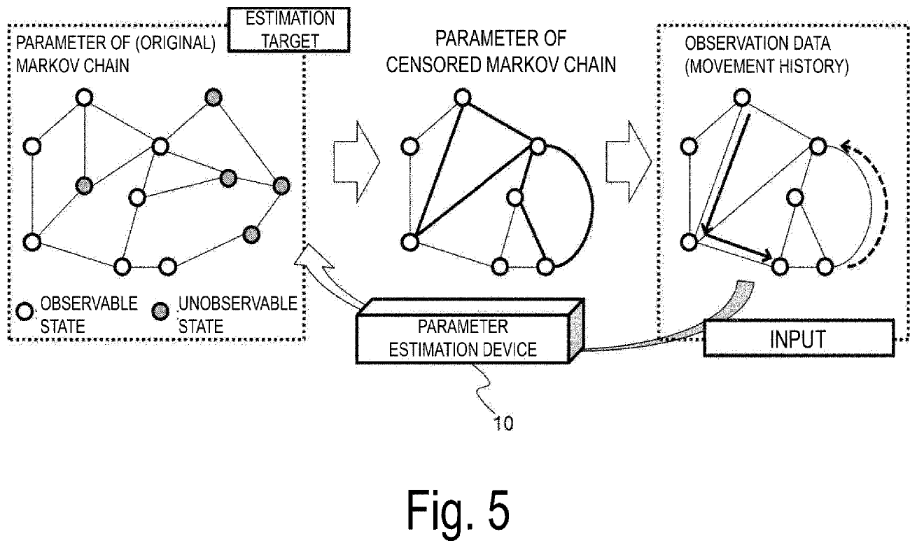

FIG. 5 illustrates an overall image of a process according to the present embodiment. The parameter estimation device 10 according to the present embodiment estimates the parameters of the original Markov chain from the parameters of the censored Markov chain that generates censored transition data based on the input observation data. This estimation can be considered as an approach of solving the inverse problem of the problem of obtaining the parameters of the censored Markov chain from the parameters of the Markov chain set forth in Theorems 1 and 2 above.

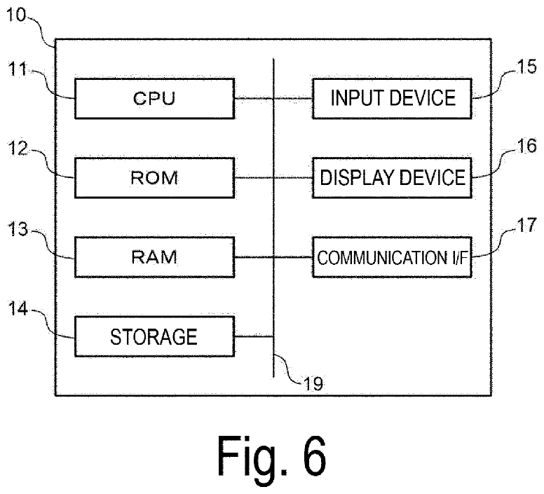

Next, a hardware configuration of the parameter estimation device 10 according to the present embodiment will be described. FIG. 6 is a block diagram illustrating a hardware configuration of a parameter estimation device.

As illustrated in FIG. 6, the parameter estimation device 10 includes a central processing unit (CPU) 11, a read only memory (ROM) 12, a random access memory (RAM) 13, a storage 14, an input device 15, a display device 16, and a communication interface (I/F) 17. The components are communicatively interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic operation processes in accordance with a program stored in the ROM 12 or the storage 14. In the present embodiment, a parameter estimation program for executing the parameter estimation process described below is stored in the ROM 12 or the storage 14.

The ROM 12 stores various programs and various kinds of data. The RAM 13 is a work area that temporarily stores a program or data. The storage 14 is constituted by a hard disk drive (HDD) or a solid state drive (SSD) and stores various programs including an operating system and various kinds of data.

The input device 15 includes a pointing device such as a mouse and a keyboard and is used for performing various inputs.

The display device 16 is, for example, a liquid crystal display and displays various kinds of information. The display device 16 may employ a touch panel system and function as the input device 15.

The communication I/F 17 is an interface for communicating with other devices and, for example, uses a standard such as Ethernet (trade name), FDDI, or Wi-Fi (trade name).

Next, a functional configuration of the parameter estimation device 10 will be described.

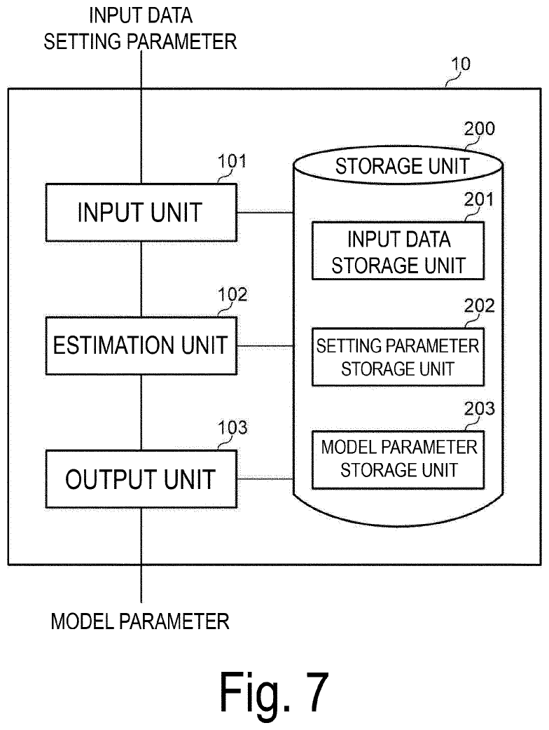

FIG. 7 is a block diagram illustrating an example of a functional configuration of the parameter estimation device 10.

As illustrated in FIG. 7, the parameter estimation device 10 includes an input unit 101, an estimation unit 102, and an output unit 103 as a functional configuration. The parameter estimation device 10 includes a storage unit 200, and the storage unit 200 is provided with an input data storage unit 201, a setting parameter storage unit 202, and a model parameter storage unit 203. Each functional component is realized by the CPU 11 reading a parameter estimation program stored in the ROM 12 or the storage 14, expanding the parameter estimation program in the RAM 13 to execute the program.

The input unit 101 receives input data and stores the input data in the input data storage unit 201. The input data includes the following data (i) to (iii).
(i) State set of original Markov chain <<X>>
(ii) Set of observable states <<O>>
(iii) Censored transition data D={Nᵢⱼ}_{ijϵ<<O>>} U {Nⁱⁿⁱₖ}_{kϵ<<O>>}

Nᵢⱼ represents the number of transitions from an observable state i ϵ <<O>> to an observable state j ϵ <<O>>, and Nⁱⁿⁱₖ represents the number of times that the observable state k ϵ <<O>> is observed as an initial state.

The input unit 101 receives setting parameters (details described below) and stores the setting parameters in the setting parameter storage unit 202.

The estimation unit 102 estimates the parameters of the model to be estimated, by using the input data stored in the input data storage unit 201 and the setting parameters stored in the setting parameter storage unit 202. The estimation unit 102 stores the estimated parameters in the model parameter storage unit 203.

Any model that represents the transition probability and the initial state probability of the original Markov chain can be utilized for the model to be estimated. The parameters of the model are written as θ=(η, λ), the model of the transition probability is written as P^{η}, and the model of the initial state probability is written as q^{λ}. A specific example of the model will be described below. The transition probability and initial state probability of the original Markov chain when this model is used are written as in Equation (6) below.

[Math. 7]

Pr(Xₜ₊₁=xᵢ|Xₜ=xᵢ,θ)=Pᵢⱼ^{ij},Pr(X₀=xᵢ|θ)=qᵢ^{λ}. (6)

Similarly to Equation (3), it is assumed that states are rearranged without loss of generality, and the matrix representation of the transition probability of the Markov chain, and the vector representation of the initial state probability are given by Equation (7) below.

$$\begin{matrix}[ Math . 8 ] & \\ \begin{matrix} & & u\end{matrix} \\ {P}^{η} = \begin{matrix} \\ u\end{matrix} ( \begin{matrix}{P}_{oo}^{η} & {P}_{ou}^{η} \\ {P}_{uo}^{η} & {P}_{uu}^{η}\end{matrix} ) , \\ \begin{matrix} & u & & \end{matrix} \\ {q}^{λ} = ( \begin{matrix}{q}_{o}^{λ} & {q}_{u}^{λ}\end{matrix} ) & ( 7 )\end{matrix}$$

The estimation unit 102 estimates the parameters by optimizing the objective function. Any function giving smaller values when the true distribution of generating data and the probability distribution of the model are close to one another, such as Kullback-Leibler divergence (KL divergence), can be utilized for the objective function. The following describes a case in which KL divergence is utilized.

The censored transition data, which is the input data, may be considered to be derived from the censored Markov chain {<<O>>, <R>*, <s>*}. <R>* and <s>* are unknown true parameters. From Theorems 1 and 2, the transition probability and the initial state probability of the censored Markov chain made from the model P^{η}, q^{λ} and observable states <<O>> are given by <R>^{η} and <s>^{ηλ} in the following Equation (8).

[Math. 9]

Pr(Xᵢ₊₁^{e}=xⱼ|Xₜ^{c}=xᵢⱼθ)=(R^{ij})ᵢⱼ,R^{η} [symbol] Pₒₒ^{η}+Pₒᵤ^{η}(I−Pᵤᵤ^{η})⁻¹Pᵤₒ^{η}Pr(X₀^{c}=xᵢ|θ)=(s^{η,λ})ᵢ,s^{η,λ} [symbol] qₒ^{λ}+qᵤ^{λ}(I−Pᵤᵤ^{η})⁻¹Pᵤₒ^{η}. (8)

Thus, KL divergence between <R>^{η} and <R>*, KL divergence between <s>^{η,λ} and <s>*, and the linear sum of the regularization terms that prevent divergence of the estimation parameters can be utilized as an objective function. The objective function can be defined by Equation (9) below, except for the terms not relying on the parameters.

[Math. 10]

[symbol]

(θ)=− [symbol] Nᵢⱼlog(R^{η})ᵢⱼ−α [symbol] N ₖⁱⁿⁱlog(s^{η,λ)}ₖ+βΩ(θ). (9)

Here, Ω(θ) is a regularization term of the parameters, and any such as L2 norm can be used. α and β are hyperparameters that define the contribution of each term to the objective function.

Any optimization technique, such as a gradient method or a Newton's method, can be applied to optimization of the objective function. In a case where a gradient method is utilized, it is only required that update of the parameters is repeated according to Expression (10) below in a k-th optimization step.

[Math. 11]

θₖ₊₁←θₖ−γₖ∇_{θ} [symbol] (θ). (10)

Here, γₖ is a learning rate parameter. The gradient of the objective function ∇_{η}<<L>>(θ) may use a function calculated and derived, or may use a numerically calculating method.

Here, examples of the input models P^{η} and q^{λ} are illustrated. The model P^{η} for the transition probability may use the model shown in Equation (11) below having a parameter η={<v>^{base}, <v>^{ftr}}.

$$\begin{matrix}[ Math . 12 ] & \\ {( {P}^{η} )}_{ij} = \{ \begin{matrix}exp \{ g ( i , j ; η ) \} / {\sum }_{k ∈ Ω} , exp \{ g ( i , k ; η ) \} ( j ∈ {Ω}_{i} ) \\ 0 ( otherwise )\end{matrix} & ( 11 )\end{matrix}$$

Here, g(i, j; η) is a score function defined by g(i, j; η)=v^{base}_{ij+φ(i, j)}^{T}_{<v>}^{ftr}, where φ(i, j) is a feature vector. The feature vector φ(i, j) is a vector with any attribute information relating to the state i and state j, and may represent, for example, a geographic distance between states, etc.

Similarly, the model q^{λ} for the initial state probability may use the model shown in Equation (12) below having a parameter λ={<w>^{base}, <w>^{ftr}}.

[Math. 13]

(q^{λ})ᵢ=exp{h(i;λ)}/Σₖexp{h(k;λ)}, (12)

Here, h (i; λ) is the score function defined by h(i; λ)=w^{base}ᵢ+Ψ(i)^{T} <w>^{ftr}, where Ψ (i) is a feature vector. The feature vector Ψ (i) is a vector with any attribute information relating to the state i, and may represent, for example, whether or not the state is a commercial region or the like.

The output unit 103 reads out and outputs the model parameter θ=(η, λ) from the model parameter storage unit 203. From this model parameter θ, the transition probability P^{η} and the initial state probability q^{λ} of the original Markov chain are obtained.

Note that in a case where all of the states are observable states <<X>>=<<O>>, the problem setting in the present embodiment is a problem of estimating the parameters from normal transition data in an ideal environment, rather than censored transition data (NPL 1).

Next, effects of the parameter estimation device 10 will be described.

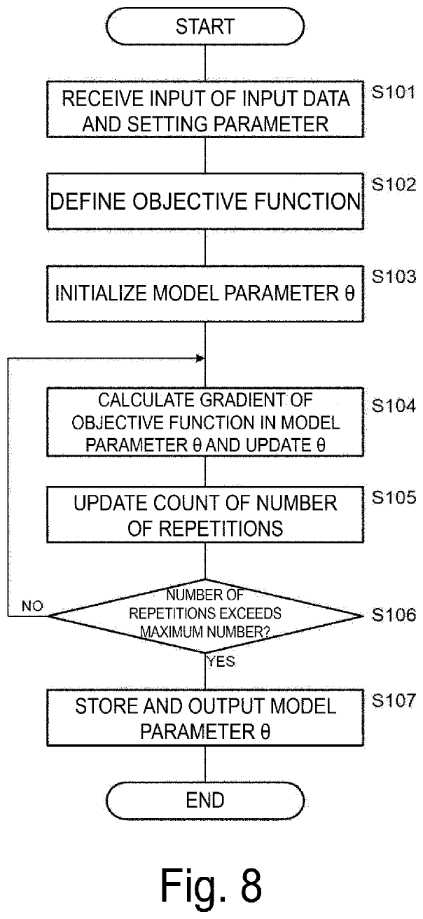

FIG. 8 is a flowchart illustrating a sequence of operations of parameter estimation processing performed by the parameter estimation device 10. The CPU 11 reads the parameter estimation program from the ROM 12 or the storage 14, expands the parameter estimation program into the RAM 13, and executes the parameter estimation program, whereby the parameter estimation process is performed.

At step S101, the CPU 11 receives, as the input unit 101, the state set of the original Markov chain <<X>>, the set of observable states <<O>>, and the censored transition data D, which are input data, and stores the input data in the input data storage unit 201. The CPU 11 receives, as the input unit 101, setting parameters such as hyperparameters α and β of the objective function, and the learning rate parameter γₖ used during optimization, and stores the parameters in the setting parameter storage unit 202.

Next, at step S102, the CPU 11 reads, as the estimation unit 102, the input data from the input data storage unit 201, reads out the setting parameters from the setting parameter storage unit 202, and defines the objective function as illustrated in Equation (9), for example.

Next, at step S103, the CPU 11 initializes, as the estimation unit 102, the model parameter θ within the objective function defined at step S102 above.

Next, at step S104, the CPU 11 calculates, as the estimation unit 102, the gradient ∇_{θ}<<L>>(θ) of the objective function in the model parameter θ, and updates θ by Expression (10).

Next, at step S105, the CPU 11 adds, as the estimation unit 102, one to the count of the number of repetitions of the optimization step of the objective function to update.

Next, at step S106, the CPU 11 determines, as the estimation unit 102, whether or not the number of repetitions exceeds a predetermined maximum number of repetitions. In a case where the number of repetitions exceeds the maximum number, the process proceeds to step S107. In a case where the number of repetitions does not exceed the maximum number, the process returns to step S104.

At step S107, the CPU 11 stores, as the estimation unit 102, the estimated model parameter θ in the model parameter storage unit 203. Then, the CPU 11 reads out and outputs, as the output unit 103, the model parameter θ stored in the model parameter storage unit 203, and the parameter estimation process ends.

As described above, the parameter estimation device according to the present embodiment receives the input data including the state set of the Markov chain to be estimated <<X>>, the set of observable states <<O>>, and the censored transition data D. Then, the parameter estimation device estimates the parameter θ(η,λ) by optimizing the objective function including terms representing the degree of match of the transition probabilities and the initial state probabilities of the next two censored Markov chains. The first one is the transition probability <R>* and the initial state probability <s>* of the censored Markov chain to generate the censored transition data D. The second one is the transition probability <R>^{η} and the initial state probability <s>^{η,λ} of the censored Markov chain created from the model representing the Markov chain to be estimated by using the parameter θ(η,λ) and the set of observable states <<O>>. In this way, according to the parameter estimation device according to the present embodiment, it is possible to estimate parameters of an original Markov chain including unobservable states from censored transition data. The possibility of such estimation allows a system represented by an original Markov chain to be learned in more detail.

Note that in the embodiments described above, a case has been described in which a gradient method is used in the optimization of the objective function for estimation of the model parameters, but the present invention is not limited thereto, and any optimization technique such as Newton's method can be used. The model of the state transition probability, the model of the initial state probability, and the regularization term of the objective function in the embodiments described above are examples, and any such model can be used.

In the embodiments described above, a case has been described in which both the term representing the degree of match of the transition probability and the term representing the degree of match of the initial state probability are included in the objective function, but the objective function according to the disclosed techniques may include at least a term representing the degree of match of the transition probability.

Note that, in each of the embodiments described above, various processors other than the CPU may execute parameter estimation processing which the CPU executes by reading software (program). Examples of the processor in such a case include a programmable logic device (PLD) such as a field-programmable gate array (FPGA) of which circuit configuration can be changed after manufacturing, a dedicated electric circuit such as an application specific integrated circuit (ASIC) that is a processor having a circuit configuration designed dedicatedly for executing a specific process, and the like. The parameter estimation process may be executed by one of such various processors or may be executed by a combination of two or more processors of the same type or different types (for example, a plurality of FPGAs, a combination of a CPU and an FPGA, or the like). More specifically, the hardware structure of such various processors is an electrical circuit obtained by combining circuit devices such as semiconductor devices.

In each of the embodiments described above, although a form in which the parameter estimation process program is stored (installed) in the ROM 12 or the storage 14 in advance has been described, the form is not limited thereto. The program may be provided in the form of being stored in a non-transitory storage medium such as a compact disc read only memory (CD-ROM), a digital versatile disc read only memory (DVD-RAM), or a universal serial bus (USB) memory. The program may be in a form that is downloaded from an external device via a network.

With respect to the above embodiments, the following supplements are further disclosed.

### Supplementary Note 1

A parameter estimation device including:
a memory; and
at least one processor connected to the memory,
wherein the processor is configured to
receive input data including a state set of a Markov chain to be estimated, a set of observable states, and censored transition data represented by a transition between the observable states and initial states of the observable states,
optimize an objective function including a term representing a degree of match of a transition probability of a first Markov chain generating the censored transition data received and a transition probability of a second Markov chain made from a model representing the Markov chain to be estimated and the set of the observable states, by using a parameter to estimate the parameter, and
output the parameter estimated.

### Supplementary Note 2

A non-transitory recording medium storing a program executable by a computer to perform a parameter estimation process,
wherein the parameter estimation process performs
receiving input data including a state set of a Markov chain to be estimated, a set of observable states, and censored transition data represented by a transition between the observable states and initial states of the observable states,
optimizing an objective function including a term representing a degree of match of a transition probability of a first Markov chain generating the censored transition data received and a transition probability of a second Markov chain made from a model representing the Markov chain to be estimated and the set of the observable states, by using a parameter to estimate the parameter, and
outputting the parameter estimated.

### REFERENCE SIGNS LIST

10 Parameter estimation device

11 CPU

12 ROM

13 RAM

14 Storage

15 Input device

16 Display device

17 Communication I/F

19 Bus

101 Input unit

102 Estimation unit

103 Output unit

200 Storage unit

201 Input data storage unit

202 Setting parameter storage unit

203 Model parameter storage unit

1. A parameter estimation device comprising circuitry configured to execute a method comprising:
receiving input data including a state set of a Markov chain to be estimated, a set of observable states, and censored transition data represented by a transition between the observable states and initial states of the observable states;
optimizing an objective function including a term representing a degree of match of a transition probability of a first Markov chain generating the received censored transition data and a transition probability of a second Markov chain made from a model representing the Markov chain to be estimated and the set of the observable states, by using a parameter to estimate the parameter; and
outputting the parameter estimated by the estimation unit.

2. The parameter estimation device according to claim 1,
wherein Kullback-Leibler divergence between the transition probability of the first Markov chain and the transition probability of the second Markov chain is used as the term representing the degree of match of the transition probability of the first Markov chain and the transition probability of the second Markov chain.

3. The parameter estimation device according to claim 1,
wherein the objective function further includes a term representing a degree of match of an initial state probability of the first Markov chain and an initial state probability of the second Markov chain.

4. The parameter estimation device according to claim 3,
wherein Kullback-Leibler divergence between the initial state probability of the first Markov chain and the initial state probability of the second Markov chain is used as the term representing the degree of match of the initial state probability of the first Markov chain and the initial state probability of the second Markov chain.

5. The parameter estimation device according to claim 1,
wherein the objective function further includes a regularization term that prevents divergence of the parameter.

6. A computer-implemented method for estimating a parameter, comprising:
receiving input data including a state set of a Markov chain to be estimated, a set of observable states, and censored transition data represented by a transition between the observable states and initial states of the observable states;
optimizing an objective function including a term representing a degree of match of a transition probability of a first Markov chain generating the received censored transition data and a transition probability of a second Markov chain made from a model representing the Markov chain to be estimated and the set of the observable states, by using a parameter;
estimating the parameter; and
outputting the estimated parameter.

7. A computer-readable non-transitory recording medium storing computer-executable program instructions that when executed by a processor cause a computer system to execute a method comprising:
receiving input data including a state set of a Markov chain to be estimated, a set of observable states, and censored transition data represented by a transition between the observable states and initial states of the observable states;
optimizing an objective function including a term representing a degree of match of a transition probability of a first Markov chain generating the received censored transition data and a transition probability of a second Markov chain made from a model representing the Markov chain to be estimated and the set of the observable states by using a parameter;
estimating the parameter; and
outputting the estimated parameter.

8. The parameter estimation device according to claim 2,
wherein the objective function further includes a term representing a degree of match of an initial state probability of the first Markov chain and an initial state probability of the second Markov chain.

9. The parameter estimation device according to claim 2,
wherein the objective function further includes a regularization term that prevents divergence of the parameter.

10. The computer-implemented method according to claim 6,
wherein Kullback-Leibler divergence between the transition probability of the first Markov chain and the transition probability of the second Markov chain is used as the term representing the degree of match of the transition probability of the first Markov chain and the transition probability of the second Markov chain.

11. The computer-implemented method according to claim 6,
wherein the objective function further includes a term representing a degree of match of an initial state probability of the first Markov chain and an initial state probability of the second Markov chain.

12. The computer-implemented method according to claim 6,
wherein the objective function further includes a regularization term that prevents divergence of the parameter.

13. The computer-readable non-transitory recording medium according to claim 7,
wherein Kullback-Leibler divergence between the transition probability of the first Markov chain and the transition probability of the second Markov chain is used as the term representing the degree of match of the transition probability of the first Markov chain and the transition probability of the second Markov chain.

14. The computer-readable non-transitory recording medium according to claim 7,
wherein the objective function further includes a term representing a degree of match of an initial state probability of the first Markov chain and an initial state probability of the second Markov chain.

15. The computer-readable non-transitory recording medium according to claim 7,
wherein the objective function further includes a regularization term that prevents divergence of the parameter.

16. The computer-implemented method according to claim 10,
wherein the objective function further includes a term representing a degree of match of an initial state probability of the first Markov chain and an initial state probability of the second Markov chain.

17. The computer-implemented method according to claim 10,
wherein the objective function further includes a regularization term that prevents divergence of the parameter.

18. The computer-implemented method according to claim 11,
wherein Kullback-Leibler divergence between the initial state probability of the first Markov chain and the initial state probability of the second Markov chain is used as the term representing the degree of match of the initial state probability of the first Markov chain and the initial state probability of the second Markov chain.

19. The computer-readable non-transitory recording medium according to claim 13,
wherein the objective function further includes a term representing a degree of match of an initial state probability of the first Markov chain and an initial state probability of the second Markov chain.

20. The computer-readable non-transitory recording medium according to claim 14,
wherein Kullback-Leibler divergence between the initial state probability of the first Markov chain and the initial state probability of the second Markov chain is used as the term representing the degree of match of the initial state probability of the first Markov chain and the initial state probability of the second Markov chain.
